(19) United States
(12) Patent Application Publication
(10) Pub. No.: US 2026/0178748 A1
(43) Pub. Date: Jun. 25, 2026

(54) STORAGE DEVICE AND OPERATION METHOD THEREOF

(71) Applicant: MACRONIX INTERNATIONAL CO., LTD., Hsinchu (TW)

(72) Inventors: Min-Zhi JI, Taichung City (TW); Shih-Chou JUAN, Taoyuan City (TW); Nai-Ping KUO, Hsinchu City (TW)

(21) Appl. No.: 18/991,858

(22) Filed: Dec. 23, 2024

(51) Int. Cl. G06F 21/60; G06F 13/40; G06F 21/79

(52) U.S. Cl. CPC G06F 21/602; G06F 13/4031; G06F 21/79

(57) ABSTRACT

The application provides a storage device and an operation method thereof. A plurality of first memory management functions are performed on a plurality of memory storage units by at least one first functional module of a storage controller coupled to the plurality of memory storage units, the storage controller further including a first accelerator bridge. A second memory management function is performed on the plurality of memory storage units by a second functional module of an accelerator externally connected to the storage controller through the first accelerator bridge, wherein the second memory management function is different from any of the first memory management functions.

### TECHNICAL FIELD

The disclosure relates to a storage device and an operation method thereof.

### BACKGROUND

An SSD (Solid State Drive) is a storage device that uses flash memory technology. Unlike traditional hard drives (HDDs), SSDs do not have mechanical parts but instead rely on electronic components for data access. This gives SSDs several significant advantages over HDDs in various aspects.

The main features and uses of SSDs are as follows. (1) High speed: The read and write speeds of SSDs are much faster than traditional hard drives because SSDs don’t require spinning disks and moving heads to locate data like HDDs do. This greatly accelerates processes like booting up, loading software, and transferring data, especially in scenarios involving large files or frequent data access. (2) No noise: Since SSDs lack mechanical moving parts, they operate silently, which is a notable advantage over the spinning noise of HDDs. (3) High durability: SSDs are more resistant to shock and vibration compared to HDDs, making them better suited for mobile devices and laptops. (4) Low power consumption: SSDs consume less power than HDDs, which is important for laptops and other power-sensitive devices. (5) Compact and lightweight: The simpler structure of SSDs makes them thinner and lighter, contributing to the portability of laptops and ultra-thin devices.

Currently, the primary uses of SSDs are as follows. (1) Operating system boot disk: SSDs can significantly improve the boot speed of an operating system, so they are commonly used as system disks to install OS. (2) Application acceleration: SSDs are used to install and run applications that require large amounts of data reading and writing (such as games, graphic design software, etc.), improving performance. (3) Data storage: SSDs can be used to store data requiring high performance, such as large databases and virtual machine environments. (4) High-performance servers: In the server field, SSDs are used to speed up data access, especially for frequently accessed data, greatly improving server responsiveness.

In summary, SSDs are faster, consume less power, and are more durable than traditional hard drives, making them ideal for scenarios that require high performance and stability.

Currently, the architectures of storage controllers (such as SSD storage controllers) are similar. Slight differences in performance come from control processes and resources, such as data buffer sizes, NAND mapping table management, or NAND operation and characterization.

As of now, SSDs may face the following areas that need improvement. (1) Design scalability: Introducing new control mechanisms into storage controllers can help improve design scalability. Currently, if a designer wants to expand the functionality of the storage controller, they need to redesign the controller and complete a tape-out process for the chip, which increases costs. (2) Optimization of operational performance: On the other hand, different NAND dies have different characteristics. Currently, a general strategy is used to adjust the parameters of NAND dies, but this does not achieve optimal operational performance. (3) Product confidentiality: In storage devices, certain information related to NAND flash memory may be confidential, but this information may need to be shared with customers to help them develop products.

Therefore, based on the above needs and the shortcomings of existing technology, the application provides a storage device.

### SUMMARY

According to one embodiment, a storage device is provided. The storage device includes: a plurality of memory storage units; a storage controller, coupled to the plurality of memory storage units, the storage controller including a first accelerator bridge and at least one first functional module, the at least one first functional module configured to perform a plurality of first memory management functions on the plurality of memory storage units; and an accelerator, externally connected to the storage controller through the first accelerator bridge, the accelerator including a second functional module configured to perform a second memory management function on the plurality of memory storage units, wherein the second memory management function is different from any of the first memory management functions.

According to another embodiment, an operation method for a storage device is provided. The operation method comprises: performing a plurality of first memory management functions on a plurality of memory storage units by at least one first functional module of a storage controller coupled to the plurality of memory storage units, the storage controller further including a first accelerator bridge; and performing a second memory management function on the plurality of memory storage units by a second functional module of an accelerator externally connected to the storage controller through the first accelerator bridge, wherein the second memory management function is different from any of the first memory management functions.

### BRIEF DESCRIPTION OF THE DRAWINGS

FIG. 1 illustrates a functional block diagram of the storage device according to one embodiment of the application.

FIGS. 2A to 2C show several different packaging methods according to one embodiment of the application.

FIG. 3 shows a functional block diagram of the storage device according to one embodiment of the application.

FIG. 4 shows a functional block diagram of the storage device according to one embodiment of the application.

FIG. 5 shows a functional block diagram of the storage device according to one embodiment of the application.

FIGS. 6A to 6D show functional block diagrams of the storage device according to different embodiments of the application.

FIG. 7 shows a functional block diagram of the storage device according to one embodiment of the application.

FIG. 8 shows a functional block diagram of the storage device according to one embodiment of the application.

FIG. 9 shows an operating method of the storage device according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In one embodiment of the application, to enhance the scalability of the storage device, an accelerator external to the storage controller is used to adjust the parameters of the NAND dies. This method allows additional means to improve the scalability of the storage device.

Therefore, in one embodiment of the application, the accelerator externally connected or coupled to the storage controller is used to accelerate or assist the storage controller. Additionally, one embodiment designs a dedicated interface for communication between the accelerator and the storage controller. This dedicated interface is positioned between the accelerator and the storage controller.

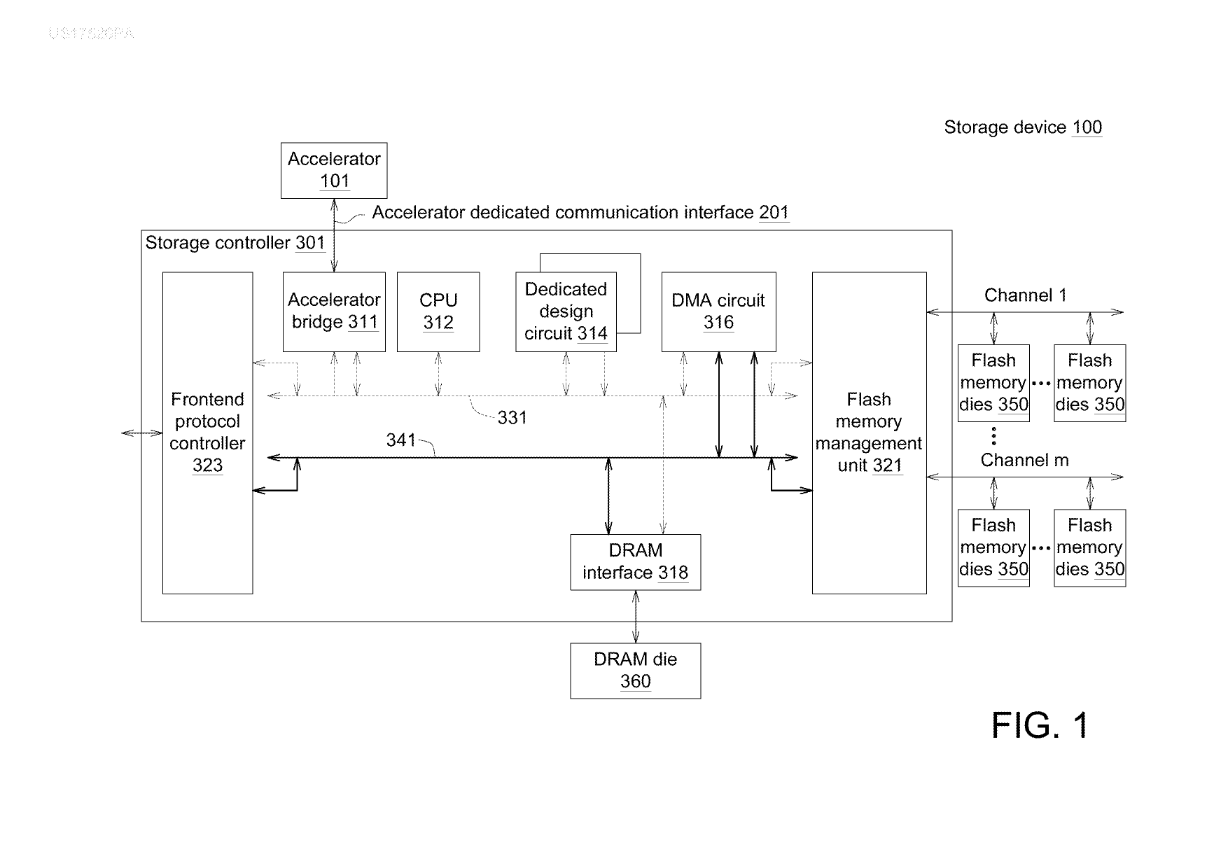

FIG. 1 illustrates a functional block diagram of the storage device according to one embodiment of the application. As shown in FIG. 1, the storage device 100 includes: an accelerator 101, an accelerator dedicated communication interface 201, a storage controller 301, multiple flash memory dies (also referred as memory storage units) 350 and at least one dynamic random access memory (DRAM) die 360. The storage controller 301 communicates with the flash memory dies 350 through at least one channels, for example, channel 1 to m (where m is a positive integer), wherein the number of channels represents the number of flash memory dies 350 the storage controller 301 can communicate with simultaneously. One or more flash memory dies 350 can connect to a single channel to share the same data bus and control signals.

In the application, "interface" refers to the signals defined between connected modules, allowing these modules to communicate through the signals. "Accelerator" refers to a module designed for specific purposes.

The storage controller 301 includes: an accelerator bridge 311, a central processing unit (CPU) 312, at least one dedicated design circuit 314, a direct memory access (DMA) circuit 316, a DRAM interface 318, a flash memory management unit 321, a frontend protocol controller 323, a control path 331, and a data path 341.

In one embodiment of the application, the direct memory access circuit 316, DRAM interface 318, flash memory management unit 321, and frontend protocol controller 323 are coupled to the data path 341.

In one embodiment of the application, the accelerator bridge 311, central processing unit 312, at least one dedicated design circuit 314, direct memory access circuit 316, DRAM interface 318, flash memory management unit 321, and frontend protocol controller 323 are coupled to the control path 331.

The accelerator bridge 311 can be implemented, for example, by using circuit blocks and/or firmware codes. The accelerator dedicated communication interface 201 is a physical input/output interface.

In one embodiment of the application, the central processing unit 312, the dedicated design circuit 314, the direct memory access circuit 316, the DRAM interface 318, the flash memory management unit 321, the frontend protocol controller 323, the control path 331, and the data path 341 are not specifically limited.

The operation of the accelerator 101 will be explained below.

In one embodiment of the application, the accelerator 101 is externally connected to the storage controller 301. Therefore, the storage controller 301 needs to support the accelerator dedicated communication interface 201 for communicating with the accelerator 101. Additionally, in one embodiment, the accelerator 101 communicates with modules/units within the storage controller 301, such as the flash memory management unit 321, via the accelerator bridge 311.

In one embodiment of the application, the accelerator 101 can assist in adjusting the flash memory (such as Data Queue Training (DQ Training) and threshold voltage tracking), adjusting the DRAM interface 318, protecting confidential parameters, and accelerating the execution of additional functions.

In other words, in one embodiment of the application, the accelerator 101 can be externally connected to the storage controller 301, enabling mutual communication and collaboration via the accelerator dedicated communication interface 201. Thus, the storage controller 301 can be designed to support the connection of the accelerator 101 to achieve hardware cooperation.

In one embodiment of the application, the role of the accelerator bridge 311 is to ensure synchronization and communication between the accelerator 101 and the internal units/modules/circuits of the storage controller 301 (such as the flash memory management unit 321), which is essential for the cooperative operation between the accelerator 101 and the storage controller 301.

In one embodiment of the application, the primary function of the accelerator 101 is to assist the storage controller 301 in high-performance operations, including: adjusting the NAND interface (such as Data Queue Training, threshold voltage tracking, etc.), which can improve the performance of NAND flash memory. Additionally, the accelerator 101 can adjust the DRAM interface 318 to ensure the accuracy and efficiency of data transmission. Furthermore, the accelerator 101 can protect confidential parameters, such as handling the protection of some confidential data or parameters, reducing the risk of potential leakage.

In one embodiment of the application, the accelerator 101 helps speed up certain functions, especially additional high-performance features, thereby enhancing the competitiveness of the storage device 100.

In one embodiment of the application, the accelerator 101 is designed to provide performance and functionality enhancements for the storage device 100 through external hardware (the accelerator 101) without modifying the existing storage controller 301.

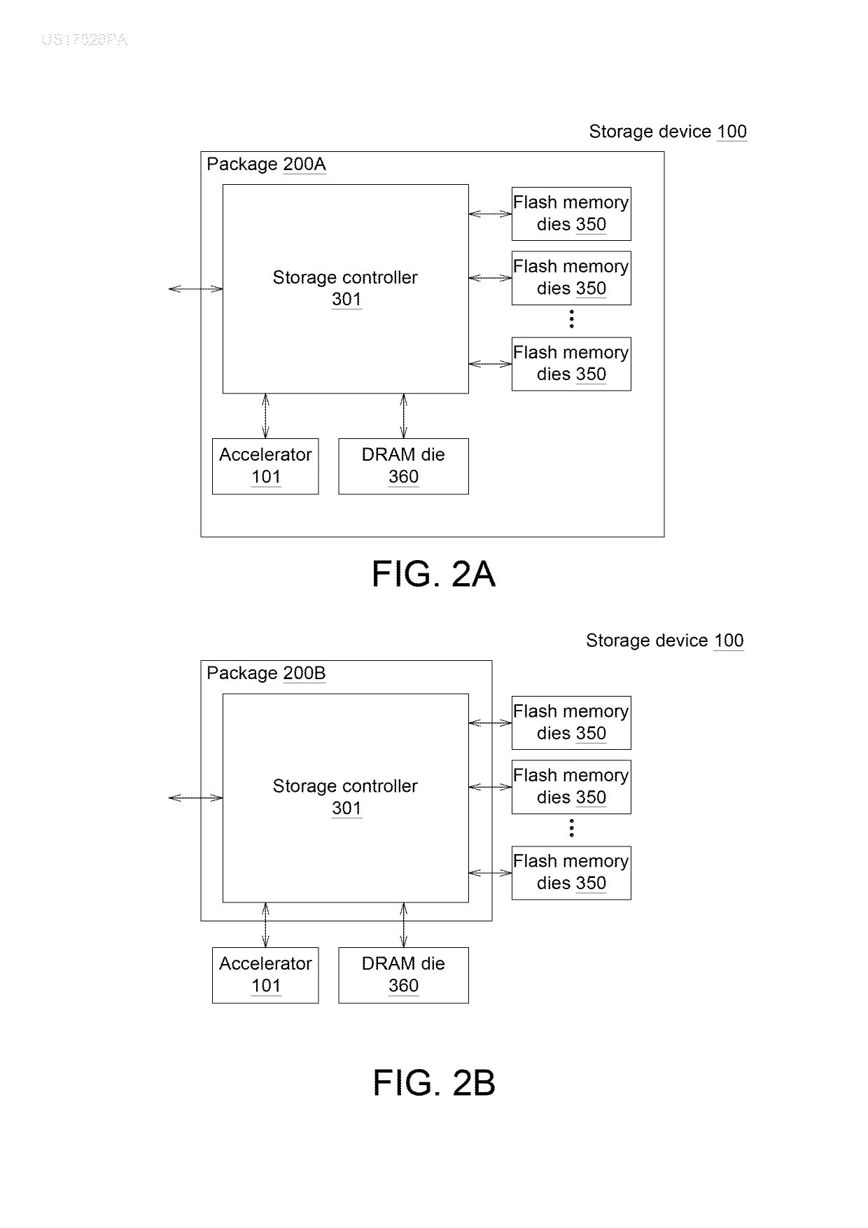

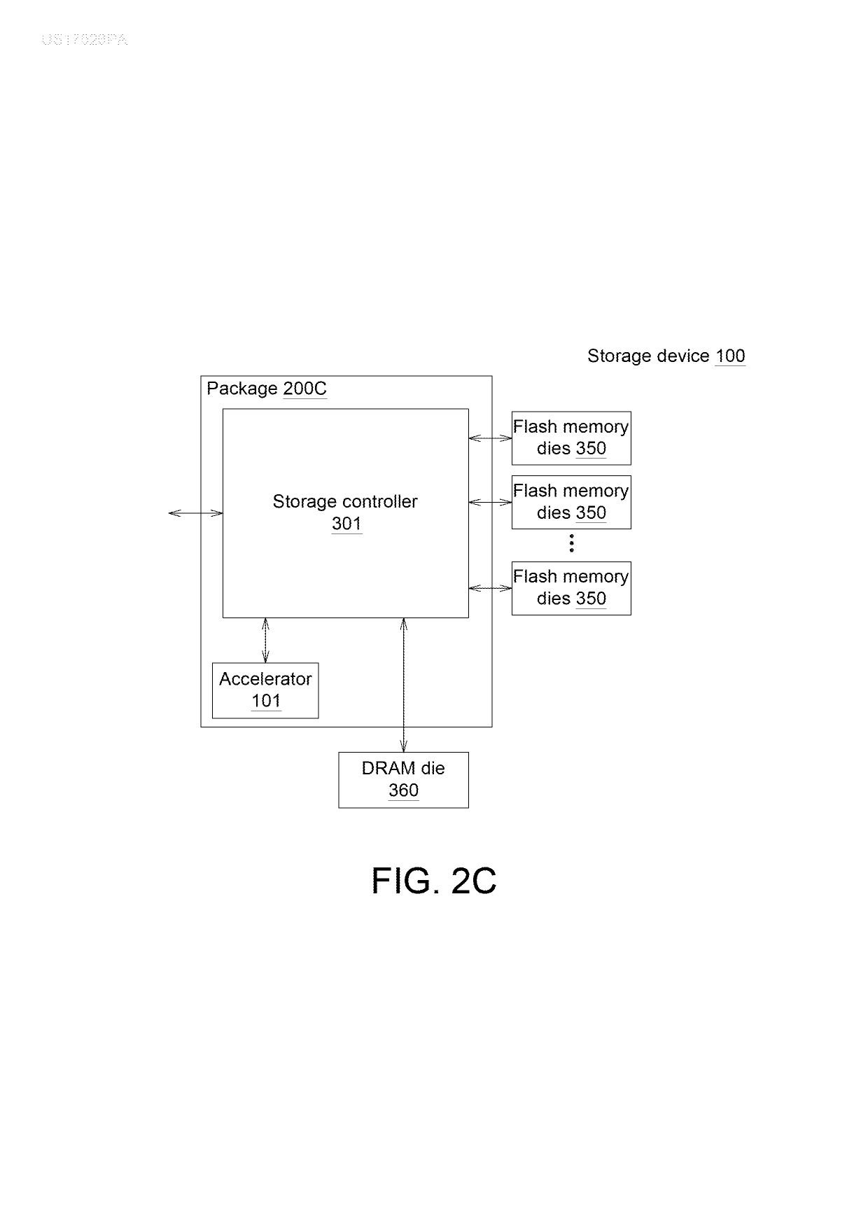

FIGS. 2A to 2C show several different packaging methods according to one embodiment of the application.

In FIG. 2A, the accelerator 101, the accelerator dedicated communication interface 201, the storage controller 301, the flash memory dies 350, and the dynamic random access memory (DRAM) die 360 are all packaged within package 200A, which results in at least one advantage that the total package size is reduced.

In FIG. 2B, the storage controller 301 is packaged within package 200B, while the accelerator 101, the accelerator dedicated communication interface 201, the flash memory dies 350, and the DRAM die 360 are not packaged within package 200B. In FIG. 2B, the storage controller 301 and the accelerator 101 are packed within different packages, which results in at least one advantage that the accelerator 101 has more flexibility and possibility to extend or support the functions which the storage controller 301 originally not supported.

In FIG. 2C, the accelerator 101, the accelerator dedicated communication interface 201, and the storage controller 301 are packaged within package 200C, while the flash memory dies 350 and the DRAM die 360 are not packaged within package 200C.

Of course, the above is merely an illustration of several possible packaging methods for one embodiment, and those skilled in the art may make modifications within the spirit of the application.

That is, based on FIGS. 2A to 2C and the spirit of the application, in one possible embodiment, the storage controller 301 and/or the accelerator 101 and/or the accelerator dedicated communication interface 201 and/or the flash memory dies 350 and/or the DRAM die 360 are packaged within one package (200A/200B/200C).

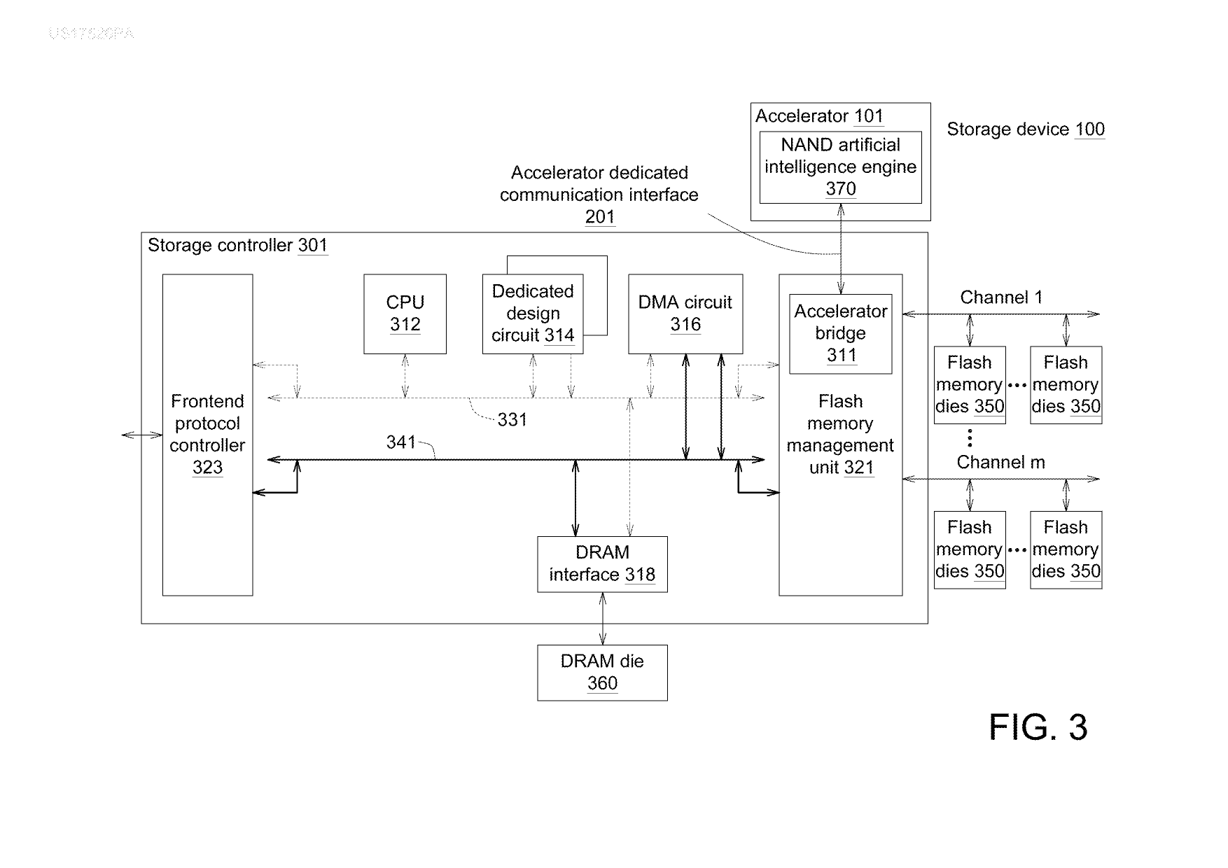

FIG. 3 shows a functional block diagram of the storage device according to one embodiment of the application. As shown in FIG. 3, in the storage device 100, the accelerator bridge 311 is located inside the flash memory management unit 321, and the accelerator 101 includes a NAND artificial intelligence engine 370, which may assist the flash memory management unit 321 in adjusting parameters of the NAND flash memory.

In other words, in the embodiment of FIG. 3, the accelerator dedicated communication interface 201 can use multiple protocols to facilitate communication between the accelerator 101 and the storage controller 301. As shown in FIG. 3, the accelerator dedicated communication interface 201 can use the Open NAND Flash Interface (ONFI) protocol, and the NAND artificial intelligence engine 370 of the accelerator 101 can act as a controller, directly issuing ONFI commands to the NAND dies 350 and adjusting parameters in the background.

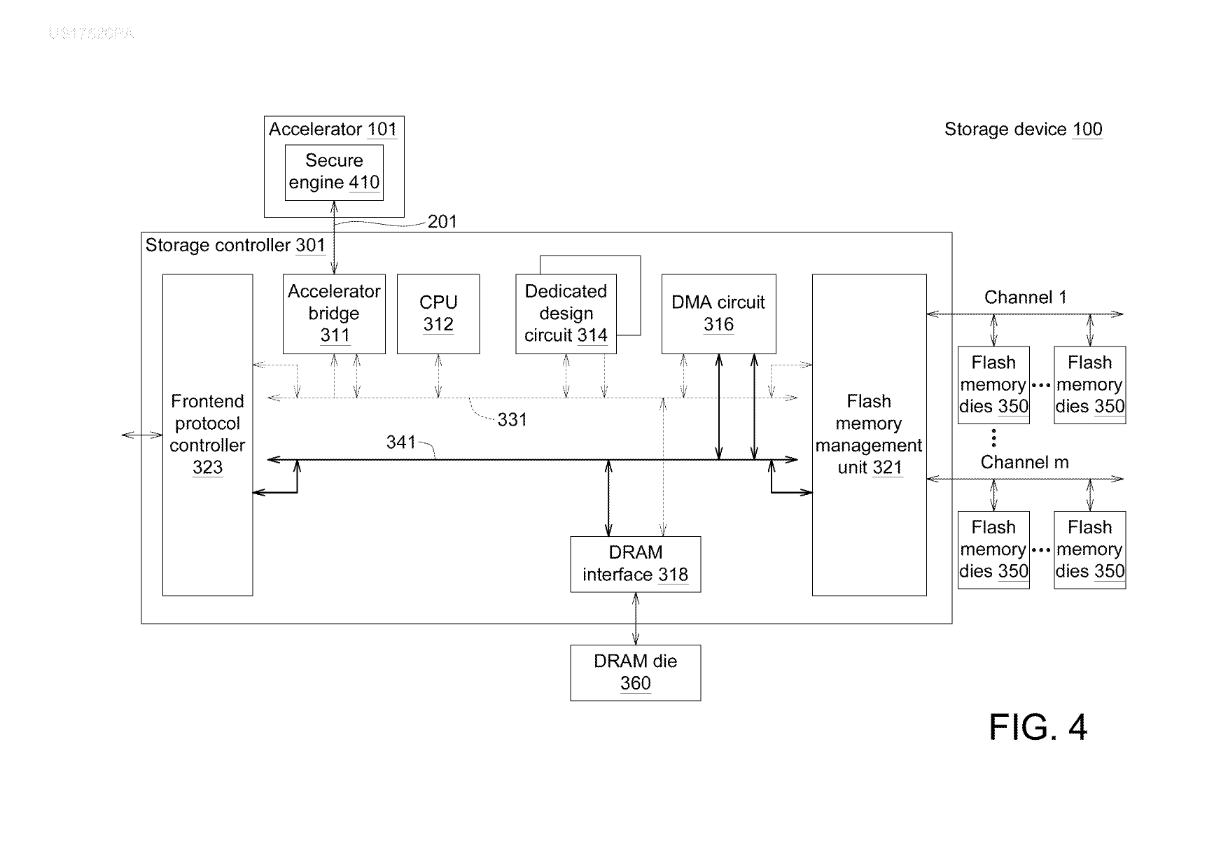

FIG. 4 shows a functional block diagram of the storage device according to one embodiment of the application. As shown in FIG. 4, in the storage device 100, the accelerator 101 includes a secure engine 410.

In FIG. 4, the accelerator 101, which includes the secure engine 410, can handle security-related tasks such as data encryption/decryption, user identity authentication or processing confidential information. Therefore, in one embodiment of the application, end-to-end protection can be achieved between the accelerator 101 and the storage controller 301. The accelerator bridge 311 handles encryption/decryption operations to protect the confidential information stored in the NAND dies 350.

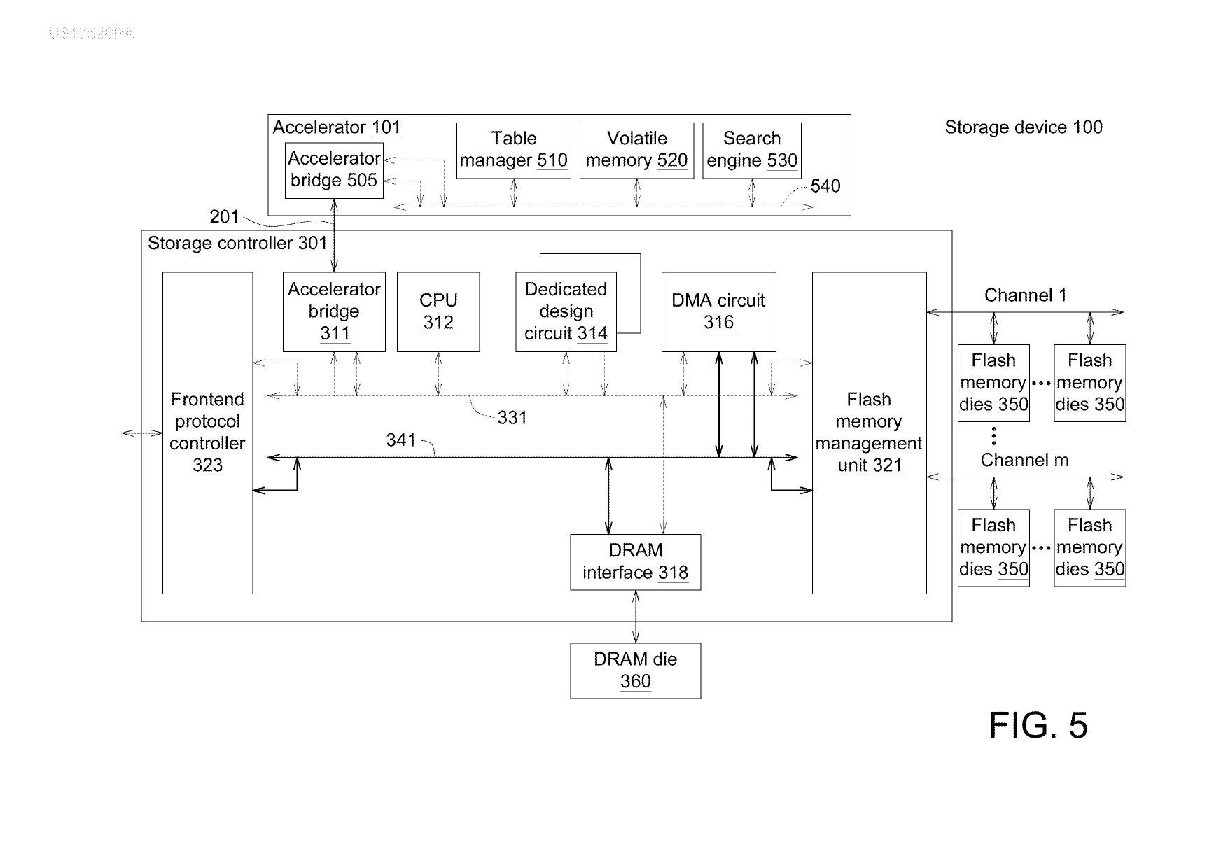

FIG. 5 shows a functional block diagram of the storage device according to one embodiment of the application. As shown in FIG. 5, in the storage device 100, the accelerator 101 includes an accelerator bridge 505, and/or a table manager 510, and/or a volatile memory 520, and/or a search engine 530. The accelerator bridge 505, the table manager 510, the volatile memory 520, and the search engine 530 are coupled to the control path 540 of the accelerator 101.

In the embodiment shown in FIG. 5, the accelerator 101 incorporates the accelerator bridge 505, which is coupled to the accelerator bridge 311 via the accelerator dedicated communication interface 201. The accelerator bridge 505 enables full-duplex communication between the accelerator 101 and the storage controller 301 and can implement complex designs within the accelerator 101 (such as a search engine). Additionally, the table manager 510 in the accelerator 101 can help manage mapping tables (used to complete the mapping from logical addresses to physical addresses).

Embodiments in FIG. 3 and FIG. 4 demonstrate a master-slave relationship. In FIG. 3, the NAND artificial intelligence engine 370 serves as the Master for assisting in controlling the Flash Memory Dies 350. In FIG. 4, the secure engine 410 functions as a slave, being controlled to retrieve corresponding security information.

However, in FIG. 5, the accelerator 101 depicts a more complex relationship. The accelerator 101 may act as a master through the table manager 510 to access internal components (e.g., the DRAM interface 318) of storage controller 301, while the volatile memory 520 may act as a slave accessed by internal components (e.g., the CPU 312) of the storage controller 301. Therefore, the accelerator bridge 505 is relied upon as a bidirectional intermediary bridge for communication.

The addition of volatile memory 520 in the accelerator 101 can be used to expand the computing capacity of the storage controller 301.

Furthermore, in other possible embodiments of the application, the accelerator 101 may optionally include a CPU to further provide additional required computing power.

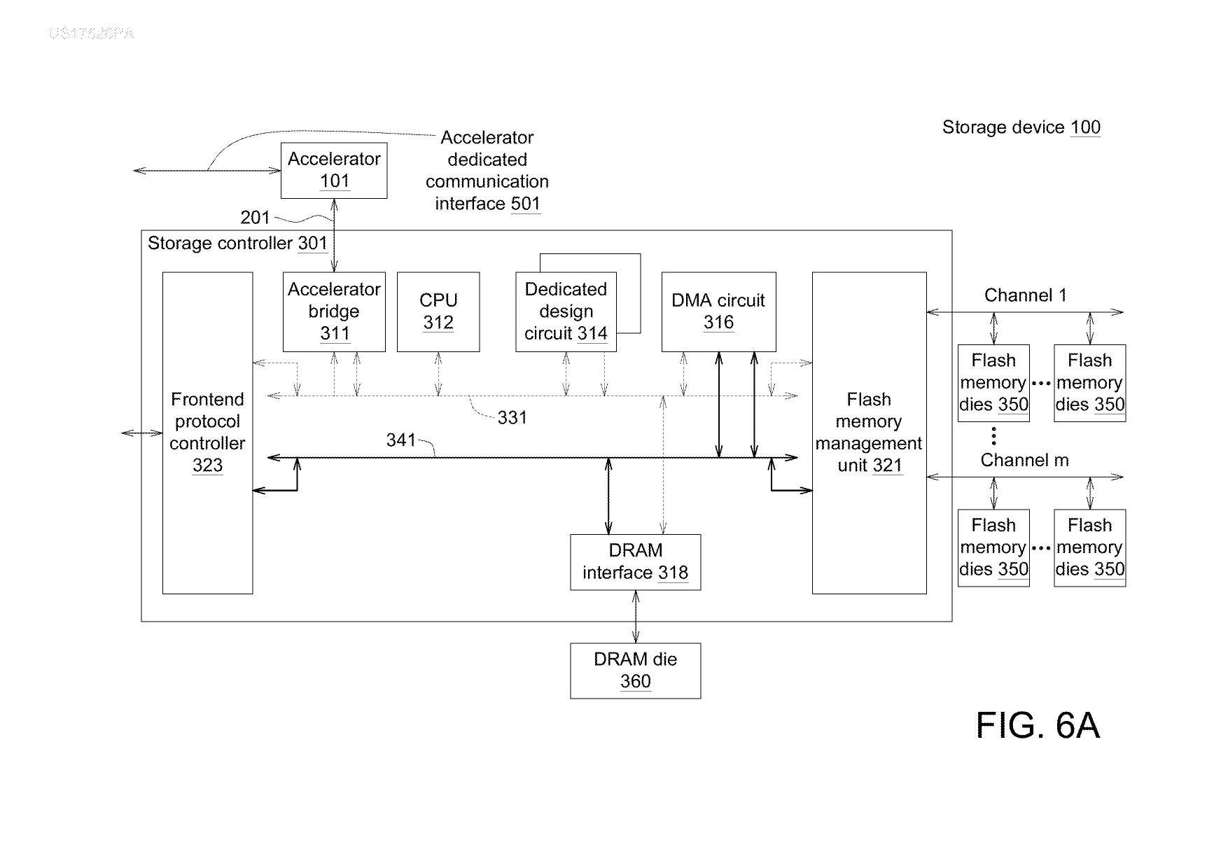

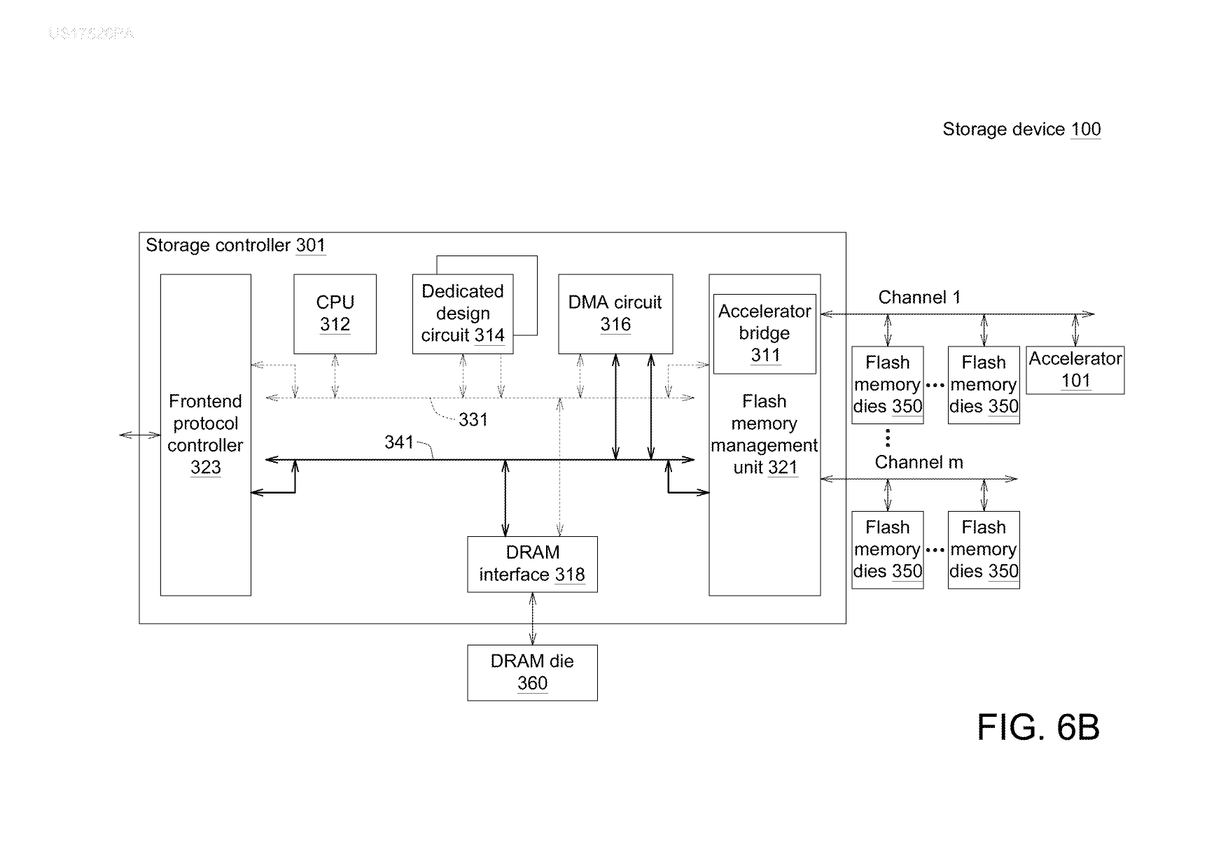

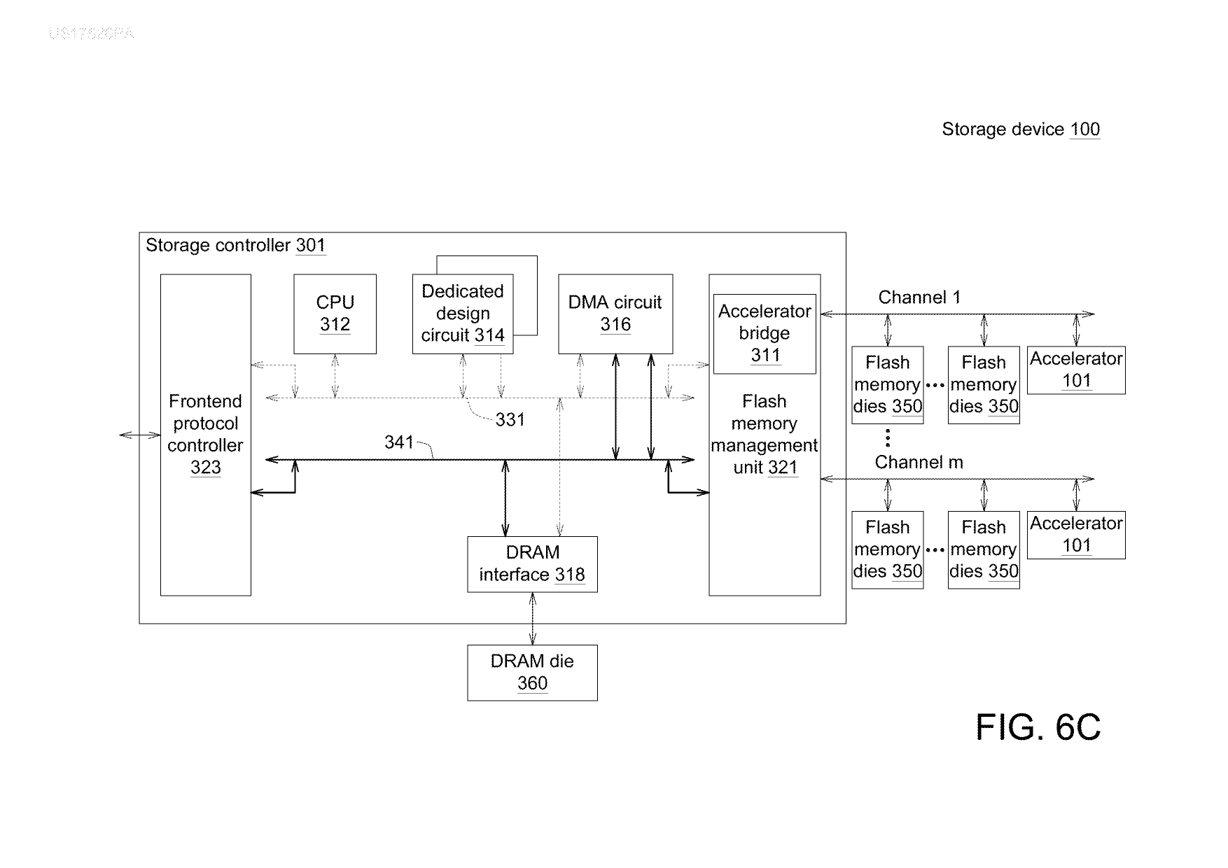

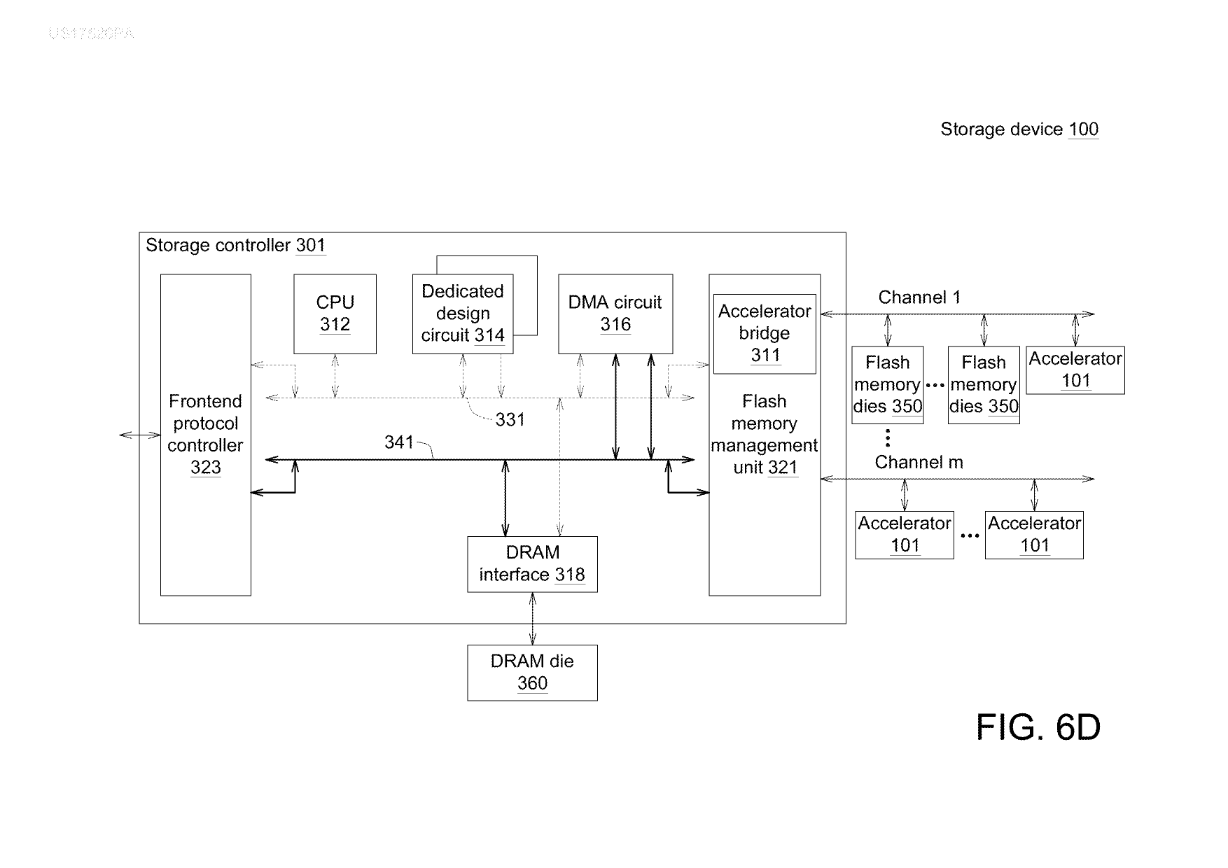

FIGS. 6A to 6D show functional block diagrams of the storage device according to different embodiments of the application.

In FIG. 6A, the accelerator 101 communicates with a host (not shown) via the accelerator dedicated communication interface 501 (also referred to as external host communication).

In FIG. 6B, the accelerator 101 uses or reuses the existing (flash memory) channel for connecting to the storage controller 301, such that no additional accelerator dedicated communication interface 201 is required as the cases in other embodiments like FIG. 1 and FIG. 3. That is, the existing (flash memory) channels are used to replace the accelerator dedicated communication interface 201. By this arrangement, the storage controller does not require the accelerator dedicated communication interface 201, which may reduce circuit area of the storage controller 301

In FIGS. 6C and 6D, the storage device 100 includes multiple accelerators 101, each of which can connect to individual flash memory channels via the flash memory channels. In FIG. 6D, multiple accelerators 101 are connected to a single channel, which is also within the spirit of the application.

In FIG. 6A, the additional dedicated communication interface 501 could be used for online training of the accelerator 101 between the accelerator 101 and the host (not shown). This allows AI models to perform offline inference on the endpoint device.

Furthermore, in FIG. 6A, the accelerator 101 can trial-run NAND management algorithms by communicating with an external host through the accelerator dedicated communication interface 501.

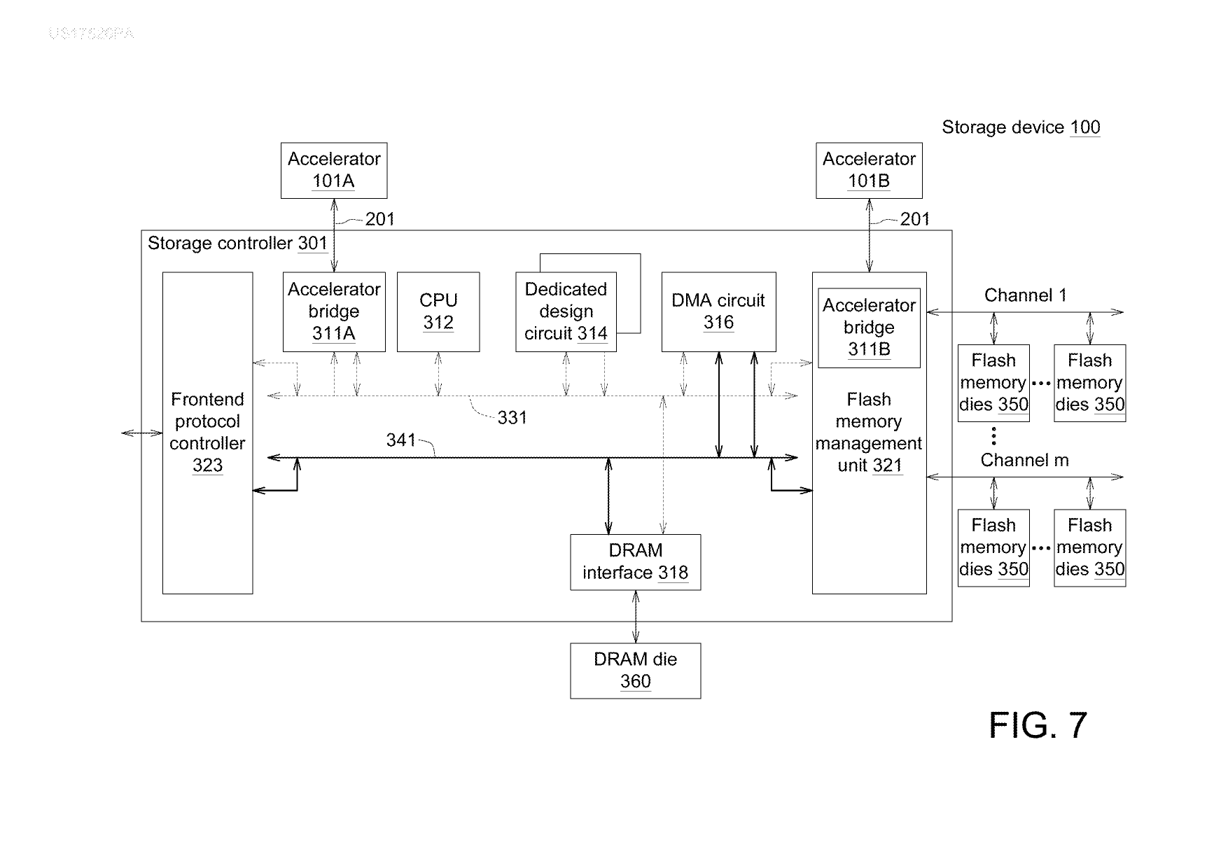

FIG. 7 shows a functional block diagram of the storage device according to one embodiment of the application. As shown in FIG. 7, the storage device 100 includes multiple accelerators 101 (101A and 101B), where one accelerator 101A interfaces with the accelerator bridge 311A, and another accelerator 101 interfaces with another accelerator bridge 311B of the flash memory management unit 321. That is, in FIG. 7, more accelerator interfaces are used to connect more accelerators 101 to the storage controller.

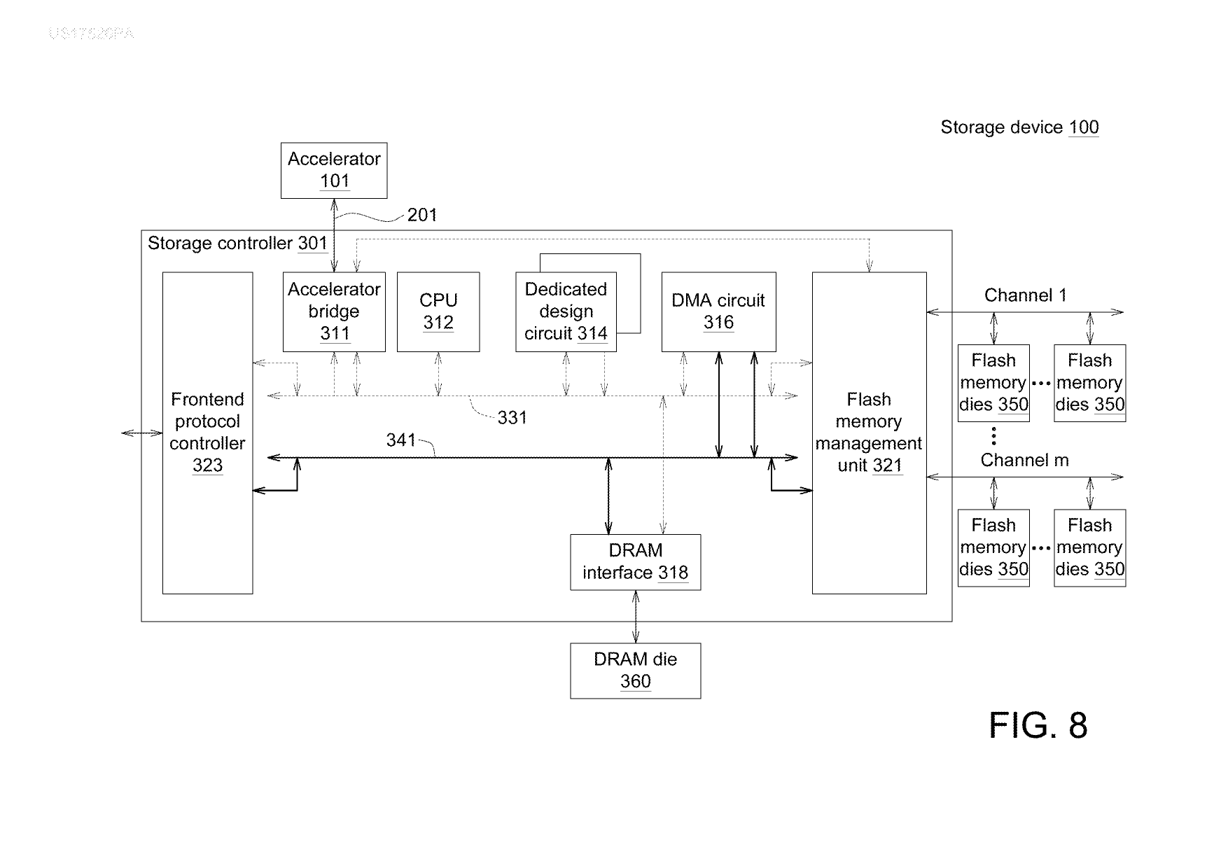

FIG. 8 shows a functional block diagram of the storage device according to one embodiment of the application. As shown in FIG. 8, the accelerator bridge 311 has an arbitration function. Due to pin limitations, in one embodiment of the application, a complexly designed accelerator bridge 311 is added to the storage device 100 to arbitrate between different modules within the storage controller 301.

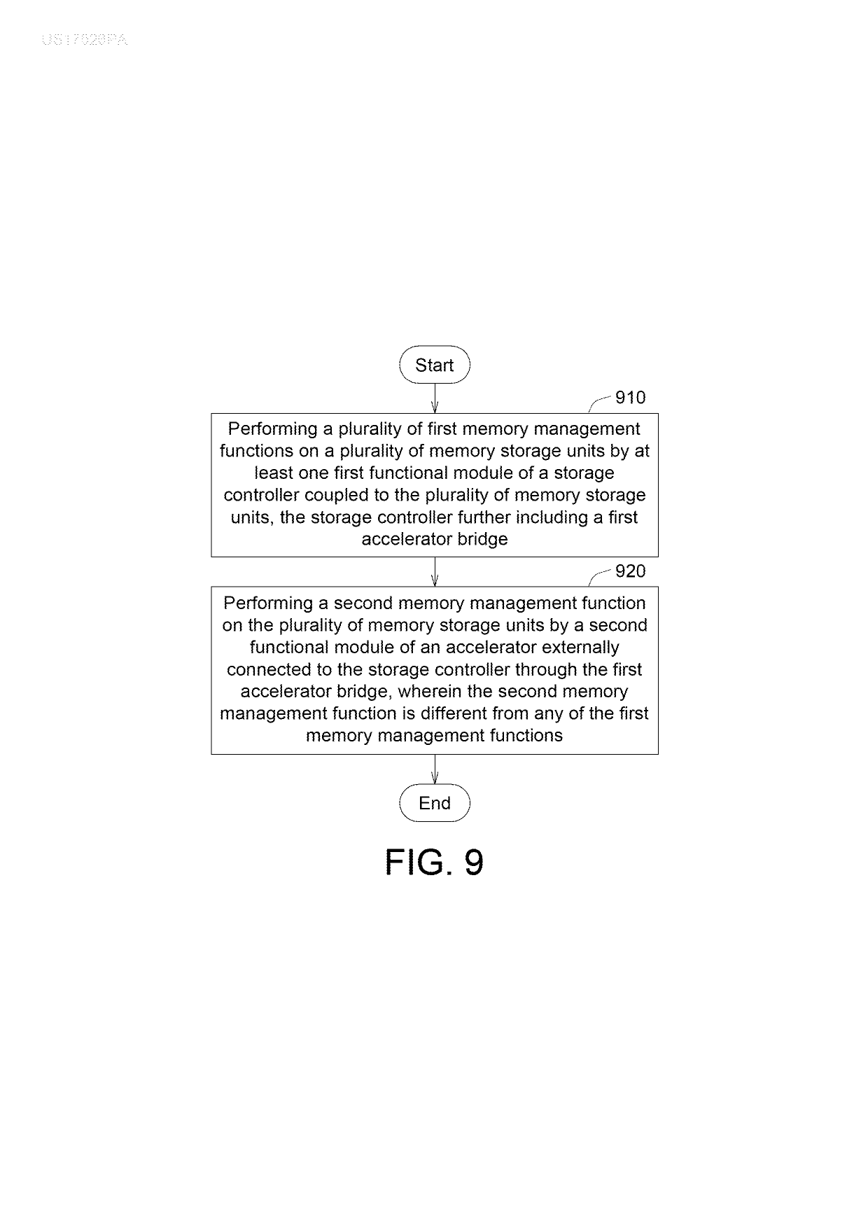

FIG. 9 shows an operating method of the storage device according to one embodiment of the application, including: (910) performing a plurality of first memory management functions on a plurality of memory storage units by at least one first functional module of a storage controller coupled to the plurality of memory storage units, the storage controller further including a first accelerator bridge; and (920) performing a second memory management function on the plurality of memory storage units by a second functional module of an accelerator externally connected to the storage controller through the first accelerator bridge, wherein the second memory management function is different from any of the first memory management functions.

Furthermore, in one embodiment of the application, the accelerator and its accelerator dedicated communication interface can be used to achieve additional functions. For example, since the front-end protocol controller has fixed protocols, and the storage device has applicable commands, these commands may not be suitable for testing the functionality of the chip. Therefore, during testing, if the existing front-end protocol controller is not desired for testing, in one embodiment of the application, the internal functions of the storage controller can be tested via the accelerator and its dedicated interface. In other words, the test commands are input into the storage controller through the accelerator and its dedicated interface, instead of through the front-end protocol controller. Alternatively, large AI models can be loaded into the storage controller via the accelerator and its accelerator dedicated communication interface, enabling the storage controller to use these externally loaded large AI models to enhance the functionality of both the storage controller and the storage device.

As can be seen from the above, in one embodiment of the application, the accelerator can extend the functionality of the storage controller, thus expanding the capabilities of the storage controller without requiring a redesign. In other words, in one embodiment of the application, functions that the storage controller lacked can be externally added to the storage controller via the accelerator.

Alternatively, in the application, because an accelerator external to the storage controller is used to support new functions/mechanisms with corresponding interfaces for communication between the accelerator and the controller, products could be upgraded at minimal cost. In the application, using an external accelerator connected to the storage controller to help adjust specific parameters of each NAND die could result in better performance. Also, in the application, if an external accelerator attached to the storage controller can assist customers in handling tasks related to confidential information, the risk of data leakage can be reduced.

The solution provided in this application has been mainly described from the perspective of interactions between the storage controller and the accelerator. It should be understood that to achieve the aforementioned functions, the storage controller and/or the accelerator may include corresponding hardware structures and/or software modules that execute the functions. It should be readily apparent to skilled person in the field that, in combination with the units and algorithm steps described in this specification, the present application can be implemented in hardware or in a form combining hardware with computer software. Whether the function is performed by hardware or by hardware driven by computer software depends on the specific application and design constraints of the technical solution. Skilled person in the field can implement the functions described for each specific application using different methods, but such implementations should not be considered beyond the scope of this application.

In one embodiment of this application, the storage controller and/or the accelerator can be divided into functional modules based on the aforementioned methods. For example, division can be made according to each corresponding function to obtain each functional module, or two or more functions can be integrated into one processing module. The integrated module can be implemented in hardware or as a software functional module. It should be noted that the division into modules in the embodiment of this application is merely exemplary and represents logical function divisions. In actual implementation, other division methods may be used. The following description uses the example of dividing into functional modules based on each corresponding function.

Although the application may describe many specific details, they should not be understood as limiting the scope of the claimed invention, but rather as characteristics of specific implementations. In the description of the application, certain features described in the context of a single embodiment may also be implemented in combination in a single embodiment. Conversely, various features described in the context of a single embodiment may also be implemented individually or in any suitable sub-combination in multiple embodiments. Furthermore, although features may be initially described as functioning in certain combinations, and even as being initially claimed as such, in some cases one or more features may be removed from the combination, and the described combination may function as a sub-combination or a variation of a sub-combination. Similarly, although operations may be depicted in the illustrations as being performed in a particular order, this should not be understood as requiring that these operations must be performed in the specific order or sequence shown, or that all depicted operations must be performed to achieve the desired results.

While the above embodiments of the application disclose only some examples and implementations, based on the disclosed content, changes, modifications, and enhancements can be made to the described examples and implementations as well as other implementations.

In summary, although the invention has been disclosed through the above embodiments, it is not intended to limit the scope of the invention. Those skilled in the relevant field, without departing from the spirit and scope of the invention, can make various changes and modifications. Therefore, the scope of protection of the invention shall be defined by the appended claims.

What is claimed is:

1. A storage device, comprising:
a plurality of memory storage units;
a storage controller, coupled to the plurality of memory storage units, the storage controller including a first accelerator bridge and at least one first functional module, the at least one first functional module configured to perform a plurality of first memory management functions on the plurality of memory storage units; and
an accelerator, externally connected to the storage controller through the first accelerator bridge, the accelerator including a second functional module configured to perform a second memory management function on the plurality of memory storage units,
wherein the second memory management function is different from any of the first memory management functions.

2. The storage device according to claim 1, further comprising a first accelerator communication interface for connecting the accelerator to the storage controller;
wherein:
the accelerator provides an additional function to the storage controller.

3. The storage device according to claim 1, wherein:
the storage controller and the accelerator are packed within the same package.

4. The storage device according to claim 1, wherein:
the storage controller and the accelerator are packed within different packages.

5. The storage device according to claim 2, wherein:
the storage controller further includes a flash memory management unit for managing the plurality of memory storage units,
the first accelerator bridge is located inside the flash memory management unit,
the accelerator includes a NAND AI engine, and
the first accelerator communication interface uses an Open NAND Flash Interface (ONFI) protocol, wherein the NAND AI engine of the accelerator sends ONFI commands to the plurality of memory storage units and adjusts at least one parameter of the plurality of memory storage units.

6. The storage device according to claim 1, wherein:
the second functional module of the accelerator includes a secure engine for performing encryption and decryption operations to protect confidential information of the plurality of memory storage units.

7. The storage device according to claim 1, wherein:
the second functional module of the accelerator includes a table management unit and/or a search engine,
the accelerator further includes a second accelerator bridge and/or a volatile memory,
the second accelerator bridge is coupled to the first accelerator bridge, facilitating full-duplex transmission between the accelerator and the storage controller;
the table management unit assists in managing mapping tables; and
the volatile memory extends computational capabilities of the storage controller.

8. The storage device according to claim 1, further comprising a second accelerator communication interface configured to connect the accelerator to an external host.

9. The storage device according to claim 1, wherein the accelerator is connected to the first accelerator bridge of the storage controller via at least one flash memory channel of the storage device.

10. The storage device according to claim 1, wherein the first accelerator bridge arbitrates between a plurality of modules in the storage controller.

11. An operation method for a storage device, the operation method comprising:
performing a plurality of first memory management functions on a plurality of memory storage units by at least one first functional module of a storage controller coupled to the plurality of memory storage units, the storage controller further including a first accelerator bridge; and
performing a second memory management function on the plurality of memory storage units by a second functional module of an accelerator externally connected to the storage controller through the first accelerator bridge,
wherein the second memory management function is different from any of the first memory management functions.

12. The operation method for a storage device according to claim 11, wherein the storage device further comprises a first accelerator communication interface for connecting the accelerator to the storage controller;
the accelerator provides an additional function to the storage controller.

13. The operation method for a storage device according to claim 11, wherein:
the storage controller and the accelerator are packed within the same package.

14. The operation method for a storage device according to claim 11, wherein:
the storage controller and the accelerator are packed within different packages.

15. The operation method for a storage device according to claim 12, wherein:
the storage controller further includes a flash memory management unit for managing the plurality of memory storage units,
the first accelerator bridge is located inside the flash memory management unit,
the accelerator includes a NAND AI engine, and
the first accelerator communication interface uses an Open NAND Flash Interface (ONFI) protocol, wherein the NAND AI engine of the accelerator sends ONFI commands to the plurality of memory storage units and adjusts at least one parameter of the plurality of memory storage units.

16. The operation method for a storage device according to claim 11, further comprising:
performing encryption and decryption operations to protect confidential information of the plurality of memory storage units by a secure engine of the second functional module of the accelerator.

17. The operation method for a storage device according to claim 11, wherein:
the second functional module of the accelerator includes a table management unit and/or a search engine,
the accelerator further includes a second accelerator bridge and/or a volatile memory,
the second accelerator bridge is coupled to the first accelerator bridge, facilitating full-duplex transmission between the accelerator and the storage controller;
the table management unit assists in managing mapping tables; and
the volatile memory extends computational capabilities of the storage controller.

18. The operation method for a storage device according to claim 11, wherein the storage device further comprising a second accelerator communication interface configured to connect the accelerator to an external host.

19. The operation method for a storage device according to claim 11, wherein the accelerator is connected to the first accelerator bridge of the storage controller via at least one flash memory channel of the storage device.

20. The operation method for a storage device according to claim 11, further comprising:
arbitrating between a plurality of modules in the storage controller by the first accelerator bridge.
